(19) United States
(12) Patent Application Publication
(10) Pub. No.: US 2021/0304531 A1
(43) Pub. Date: Sep. 30, 2021

(54) INFORMATION PROCESSING APPARATUS, INFORMATION PROCESSING METHOD, AND STORAGE MEDIUM

(71) Applicant: TOYOTA JIDOSHA KABUSHIKI KAISHA, Toyota-shi (JP)

(72) Inventors: Hirokazu Kano, Nagoya-shi (JP); Masatoshi Hayashi, Nisshin-shi (JP); Reita Kamei, Nagoya-shi (JP); Namika Hara, Kameyama-shi (JP)

(73) Assignee: TOYOTA JIDOSHA KABUSHIKI KAISHA, Toyota-shi (JP)

(21) Appl. No.: 17/201,770

(22) Filed: Mar. 15, 2021

(30) Foreign Application Priority Data
Mar. 31, 2020 (JP) 2020-063512

(51) Int. Cl. G07C 9/00; G07C 9/27

(52) U.S. Cl. CPC G07C 9/00182; G07C 9/27; G07C 2009/00769; G07C 2009/00198; G07C 2009/00206; G07C 2009/00261

(57) ABSTRACT

An information processing apparatus, comprises a storage configured to store two or more electronic keys corresponding to two or more locking-unlocking apparatuses, respectively; and a controller configured to perform selection of an electronic key to be used, from among the two or more electronic keys, and transmission of the selected electronic key to a corresponding locking-unlocking apparatus of the two or more locking-unlocking apparatuses.

### CROSS REFERENCE TO THE RELATED APPLICATION

This application claims the benefit of Japanese Patent Application No. 2020-063512, filed on Mar. 31, 2020, which is hereby incorporated by reference herein in its entirety.

### BACKGROUND

### Technical Field

The present disclosure relates to a technique of performing locking and unlocking by using an electronic key.

### Description of the Related Art

There is an increasing number of apparatuses that can be locked and unlocked by using an electronic key. For example, smart keys are in widespread use in the automotive field, and there are signs that electronic locks using a card key, a mobile device, and the like become popular also in housing.

In this respect, Japanese Patent Laid-Open No. 2019-109846 discloses a system that unlocks a vehicle when a predetermined condition of use is satisfied, in addition to an electronic key.

### SUMMARY

When apparatuses that can be unlocked by using an electronic key increase in close surroundings, a problem can arise that management of electronic keys is complicated.

The present disclosure has been made in view of such a problem, and an object of the present disclosure is to enhance usability in a system using an electronic key.

The present disclosure in its one aspect provides an information processing apparatus, comprising: a storage configured to store two or more electronic keys corresponding to two or more locking-unlocking apparatuses, respectively; and a controller configured to perform selection of an electronic key to be used, from among the two or more electronic keys, and transmission of the selected electronic key to a corresponding locking-unlocking apparatus of the two or more locking-unlocking apparatuses.

The present disclosure in its another aspect provides an information processing method, comprising: acquiring two or more electronic keys corresponding to two or more locking-unlocking apparatuses, respectively; selecting an electronic key to be used, from among the two or more electronic keys; and transmitting the selected electronic key to a corresponding locking-unlocking apparatus of the two or more locking-unlocking apparatuses.

Another aspect may be a program for causing a computer to execute the information processing method, or a computer-readable storage medium storing the program in a non-transitory manner.

According to the present disclosure, usability can be enhanced in a system using an electronic key.

### BRIEF DESCRIPTION OF THE DRAWINGS

FIG. 1 is a schematic diagram of an authentication system according to a first embodiment;

FIG. 2 is block diagrams schematically illustrating an example of components included in the system;

FIG. 3 illustrates an example of key data in the first embodiment;

FIG. 4 illustrates a configuration of software operating on a mobile terminal;

FIGS. 5A, 5B are examples of screens displayed on the mobile terminal;

FIGS. 6A, 6B are examples of a screen displayed on the mobile terminal;

FIG. 7 is a flowchart of processing performed by the mobile terminal in the first embodiment;

FIG. 8 is an example of history data in a second embodiment;

FIG. 9 is a flowchart of processing performed by the mobile terminal in the second embodiment;

FIG. 10 is a flowchart of processing performed by the mobile terminal in a third embodiment; and

FIG. 11 is a diagram for describing processing of determining a combination of electronic keys that tend to be used in succession.

### DESCRIPTION OF THE EMBODIMENTS

An information processing apparatus according to an aspect of the present disclosure is an apparatus that transmits an electronic key to a locking-unlocking apparatus through wireless communication. The information processing apparatus can be, for example, a smartphone or any other mobile terminal.

Specifically, the information processing apparatus includes: a storage configured to store two or more electronic keys corresponding to two or more locking-unlocking apparatuses, respectively; and a controller configured to perform selection of an electronic key to be used, from among the two or more electronic keys, and transmission of the selected electronic key to a corresponding locking-unlocking apparatus of the two or more locking-unlocking apparatuses.

By making a configuration such that the plurality of respective electronic keys corresponding to the plurality of locking-unlocking apparatuses are stored in the storage and that the selected electronic key can be transmitted, a user can access the plurality of locking-unlocking apparatuses only by carrying a single apparatus.

The controller may receive, from any one of the two or more locking-unlocking apparatuses that is in a vicinity of the information processing apparatus, an identifier of the locking-unlocking apparatus, and may select and transmit the electronic key to be used, based on the identifier.

For example, an electronic key to be transmitted can be selected by identifying a locking-unlocking apparatus within a communication range, and the electronic key can be automatically transmitted. Thus, the user can perform locking or unlocking, for example, even with both hands full.

The information processing apparatus may further include an input-output unit configured to present information to a user and to acquire an input from the user, and the controller may output a list of the two or more electronic keys to the input-output unit, and may select the electronic key to be used, based on an operation by the user.

Provision of the input-output unit enables the user to select an arbitrary electronic key. The list is generated, preferably, by using, for example, a graphic from which types of the keys can be intuitionally recognized, but may take any form.

The controller may be capable of executing a first program that performs the selection and the transmission of the electronic key, and may activate the first program when a predetermined gesture is detected through the input-output unit.

The first program is an application program for transmitting an electronic key. By making a configuration such that the first program is activated by the predetermined gesture, key-related functionality can be used at any timing.

The controller may activate the first program when it is detected that at least any one of the two or more locking-unlocking apparatuses is in a vicinity of the information processing apparatus.

According to such a configuration, for example, when the user comes in front of a locking-unlocking apparatus, an electronic key selection screen can be automatically displayed.

The controller may receive, from the locking-unlocking apparatus in the vicinity, an identifier of the locking-unlocking apparatus, and may select the electronic key to be used, based on the identifier.

For example, a corresponding electronic key may be automatically selected based on the received identifier, and the transmission of the electronic key may be triggered by user approval.

The controller may have the storage store a history of use of each of the two or more electronic keys, and may perform presentation of an electronic key candidate predicted to be used to the user, based on the history of use.

By suggesting the electronic key candidate based on the history of use of each electronic key, time and work for searching the list for a target electronic key can be saved. For example, methods for the presentation of an electronic key candidate to the user include, but are not limited to, a method in which an electronic key expected to be used is displayed high in the list, a method in which an electronic key expected to be used is highlighted in the list, a method in which an electronic key expected to be used is pointed with a cursor (displayed in an already selected state), and the like.

The controller may calculate a likelihood of each of the two or more electronic keys being used, based on the history of use, and may perform the presentation, based on the likelihoods.

By calculating a likelihood, that is, a probability that each electronic key is used, an electronic key that is more likely to be used can be proposed to the user.

The controller may extract a combination of two or more electronic keys that tend to be used in succession, based on the history of use, and when a first electronic key is used, may perform presentation to the user of a second electronic key that tends to be used following the first electronic key.

For example, when unlocking of a car tends to be performed after locking of a home door is performed, an electronic key corresponding to the car may be presented to the user at a timing when an electronic key corresponding to the home is used.

The presentation may be performed by highlighting a target electronic key included in the list.

Highlighting may be, for example, to visually intensify, or to display an item on the list in an already selected state.

Hereinafter, embodiments of the present disclosure will be described based on drawings. Configurations according to the embodiments below are presented for illustrative purposes, and the present disclosure is not limited to such configurations according to the embodiments.

### First Embodiment

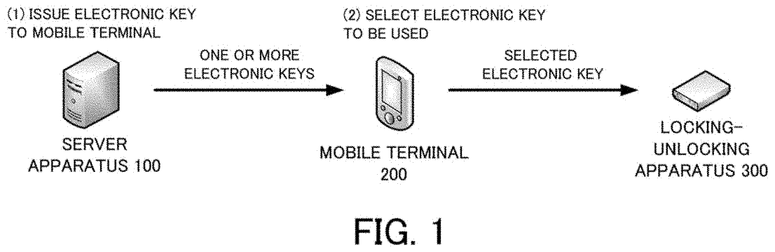

An outline of an authentication system according to a first embodiment will be described with reference to FIG. 1. The system according to the present embodiment includes a server apparatus 100 that issues an electronic key, a mobile terminal 200 owned by a user, and one or more locking-unlocking apparatuses 300 respectively installed in equipment (for example, a home, a facility, a building, a vehicle, or the like) that is used by the user.

In the system according to the present embodiment, the server apparatus 100 issues data (an electronic key) for performing authentication to the mobile terminal 200. The mobile terminal 200 transmits the electronic key to the locking-unlocking apparatus 300 through wireless communication, and the locking-unlocking apparatus 300 performs authentication on the electronic key and, when the authentication succeeds, locks or unlocks an electronic lock. Thus, the user can perform locking and unlocking of target equipment or the like only with the mobile terminal 200, without using a physical key.

Components of the system will be described in detail.

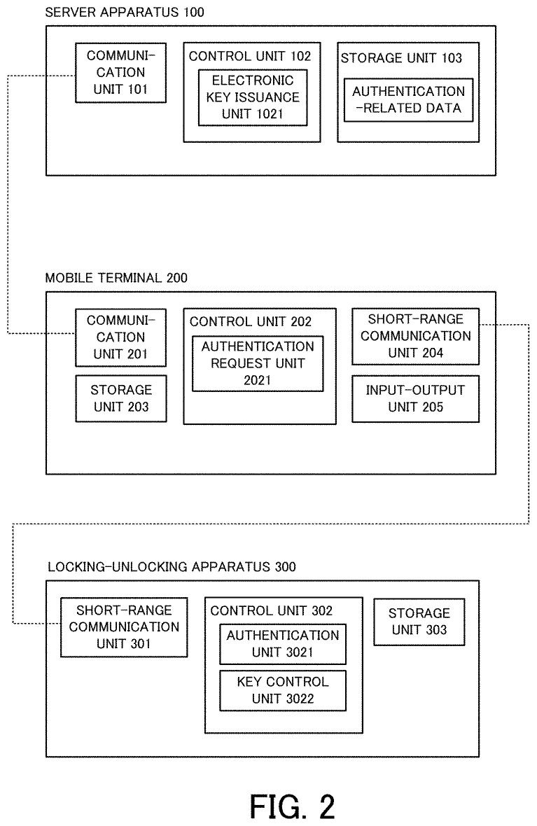

FIG. 2 is block diagrams schematically illustrating an example of the server apparatus 100, the mobile terminal 200, and the locking-unlocking apparatus 300 depicted in FIG. 1.

The server apparatus 100 is an apparatus that performs processing of issuing an electronic key in response to a request from the mobile terminal 200.

The server apparatus 100 can be configured by using a general-purpose computer. In other words, the server apparatus 100 can be configured as a computer including a processor such as a CPU or a GPU, a main memory such as a RAM or a ROM, and an auxiliary storage device such as an EPROM, a hard disk drive, or a removable medium. The removable medium may be, for example, a USB memory or a disk recording medium such as a CD or a DVD. The auxiliary storage device stores an operating system (OS), various programs, various tables, and the like, and each function matching with a predetermined purpose, which will be described later, can be implemented by executing the programs stored in the auxiliary storage device. However, one or some, or all, of the functions may be implemented by a hardware circuit such as an ASIC or an FPGA.

The server apparatus 100 includes a communication unit 101, a control unit 102, and a storage unit 103.

The communication unit 101 is a unit configured to connect the server apparatus 100 to a network. In the present embodiment, communication can be performed with another apparatus (for example, the mobile terminal 200) via the network by using a mobile communication service such as 4G or LTE.

The control unit 102 is a unit configured to govern control of the server apparatus 100. The control unit 102 is configured, for example, by using the CPU.

The control unit 102 includes, as a function module, an electronic key issuance unit 1021. The function module may be implemented by the CPU executing a program stored in storage such as a ROM.

The electronic key issuance unit 1021 issues an electronic key in response to a request from the mobile terminal 200. The electronic key is digital data for allowing the mobile terminal 200 to be authenticated by the locking-unlocking apparatus 300.

When a request to issue an electronic key is received from the mobile terminal 200, the electronic key issuance unit 1021 issues an electronic key corresponding to the mobile terminal 200. The electronic key may be acquired from an electronic key stored beforehand, or may be generated dynamically. For example, an electronic key that is valid only for a predetermined time period of day, an electronic key that can be used a specified number of times (for example, a one-time key or the like), an electronic key that can be used only on a predetermined mobile terminal 200, or the like can also be generated.

Note that when the mobile terminal 200 accesses a plurality of the locking-unlocking apparatuses 300, the electronic key issuance unit 1021 can issue a plurality of electronic keys to the mobile terminal 200, for the target locking-unlocking apparatuses 300, respectively.

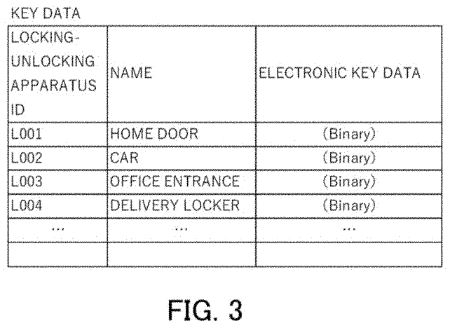

FIG. 3 illustrates data transmitted to the mobile terminal 200 when electronic keys are issued. As illustrated, the electronic key issuance unit 1021 transmits an identifier of each locking-unlocking apparatus (locking-unlocking apparatus ID), a name of the apparatus (a name of equipment), and corresponding electronic key data (binary data) that are associated with each other, as key data, to the mobile terminal 200.

The storage unit 103 is a unit configured to store information and is configured by using a storage medium such as a RAM, a magnetic disk, or a flash memory. The storage unit 103 stores various data (authentication-related data) and the like for generating an electronic key.

Next, the mobile terminal 200 will be described.

The mobile terminal 200 is, for example, a small-sized computer such as a smartphone, a mobile telephone, a tablet terminal, a personal digital assistant, or a wearable computer (a smartwatch or the like). The mobile terminal 200 includes a communication unit 201, a control unit 202, a storage unit 203, a short-range communication unit 204, and an input-output unit 205.

Similarly to the communication unit 101, the communication unit 201 is a communication interface for performing communication with the server apparatus 100 via the network.

The control unit 202 is a unit configured to govern control of the mobile terminal 200. The control unit 202 is configured, for example, by using a microcomputer. Functions of the control unit 202 may be implemented by a CPU executing programs stored in the storage unit 203, which will be described later.

The control unit 202 includes, as a function module, an authentication request unit 2021. The function module may be implemented by the CPU executing a program stored in storage (ROM or the like).

The authentication request unit 2021 performs processing of acquiring an electronic key from the server apparatus 100, and processing of transmitting an electronic key selected by the user to the locking-unlocking apparatus 300 and requesting authentication.

First, the authentication request unit 2021 performs the processing of acquiring an electronic key. In the present embodiment, the authentication request unit 2021 transmits a request to issue an electronic key to the server apparatus 100, receives key data transmitted from the server apparatus 100, and has the storage unit 203, which will be describe later, store the key data.

Second, the authentication request unit 2021 provides an operation screen to the user via the input-output unit 205, which will be described later, and, based on an operation performed by the user, generates a request for locking or unlocking. For example, the authentication request unit 2021 outputs an icon for unlocking, an icon for locking, or the like to a touch panel display, and, based on an operation performed by the user, generates data that requests locking or unlocking (locking/unlocking request). The locking/unlocking request is transmitted to the locking-unlocking apparatus 300, together with the electronic key.

Note that the operation performed by the user is not limited to an operation performed via the touch panel display. For example, the operation performed by the user may be an operation performed by using a hardware switch or the like.

Note that when the mobile terminal 200 has no electronic key, locking operation and unlocking operation from the operation screen are impossible.

The electronic key acquired by the mobile terminal 200 may be a fixed key or may be a one-time key. In any case, authentication information corresponding to the electronic key is stored beforehand in the locking-unlocking apparatus 300.

The storage unit 203 is a unit configured to store information and is configured by using a storage medium such as a RAM, a magnetic disk, or a flash memory. The storage unit 203 stores the key data transmitted from the server apparatus 100, the various programs to be executed by the control unit 202, data, and the like.

The short-range communication unit 204 is an interface for performing short-range wireless communication with the locking-unlocking apparatus 300. The short-range communication unit 204 performs communication over short distances (approximately several centimeters) by using a predetermined wireless communication standard.

In the present embodiment, the short-range communication unit 204 performs data communication according to an NFC (Near Field Communication) standard. Although NFC is used in the present embodiment for an illustrative purpose, other wireless communication standards can also be used. For example, Bluetooth®, UWB (Ultra Wideband), Wi-Fi®, or the like can also be used.

The input-output unit 205 is a unit configured to receive an input operation performed by the user and presenting information to the user. Specifically, the input-output unit 205 includes a touch panel and a unit for controlling the touch panel, and a liquid crystal display and a unit for controlling the liquid crystal display. In the present embodiment, the touch panel and the liquid crystal display are configured by using a single touch panel display.

Next, the locking-unlocking apparatus 300 will be described.

The locking-unlocking apparatus 300 is an apparatus for locking and unlocking a door of a predetermined piece of equipment, a facility, or a building, and is an apparatus included as part of a smart key system.

The locking-unlocking apparatus 300 includes a function of performing short-range wireless communication with the mobile terminal 200 and authenticating the mobile terminal 200, and a function of locking or unlocking an electronic lock based on a result of authenticating the mobile terminal 200. The locking-unlocking apparatus 300 includes a short-range communication unit 301, a control unit 302, and a storage unit 303.

The short-range communication unit 301 is a unit configured to perform communication with the mobile terminal 200, according to the same communication standard that is used by the short-range communication unit 204.

The control unit 302 is a module that performs control of authenticating the mobile terminal 200 based on an electronic key acquired from the mobile terminal 200 via the short-range communication unit 301, and control of locking or unlocking an electronic lock based on a result of the authentication. The control unit 302 is configured, for example, by using a microcomputer.

The control unit 302 includes, as function modules, an authentication unit 3021 and a key control unit 3022. Each function module may be implemented by a CPU executing programs stored in storage (ROM or the like).

The authentication unit 3021 performs authentication of the mobile terminal 200, based on an electronic key transmitted from the mobile terminal 200. Specifically, the authentication unit 3021 matches the electronic key transmitted from the mobile terminal 200 against authentication information stored in the storage unit 303 and, when a match occurs, determines that authentication succeeds. When a match does not occur, it is determined that authentication fails. When the authentication unit 3021 successfully authenticates the mobile terminal 200, an instruction for locking or unlocking is transmitted to the key control unit 3022, which will be described later.

Note that a scheme for the authentication performed by the authentication unit 3021 may be a scheme in which parity is verified by simply comparing the authentication information, or may be a scheme using asymmetric encryption.

The storage unit 303 is a unit configured to store information and is configured by using a storage medium such as a RAM, a magnetic disk, or a flash memory. The storage unit 303 stores the authentication information to be matched against an electronic key transmitted from the mobile terminal 200, various programs to be executed by the control unit 302, data, and the like.

Next, a method by which the mobile terminal 200 selects an electronic key will be described.

As mentioned above, the storage unit 203 included in the mobile terminal 200 can store a plurality of electronic keys received from the server apparatus.

The control unit 202 included in the mobile terminal 200 is configured to be capable of executing a plurality of application programs, in addition to processing that handles an electronic key as described above.

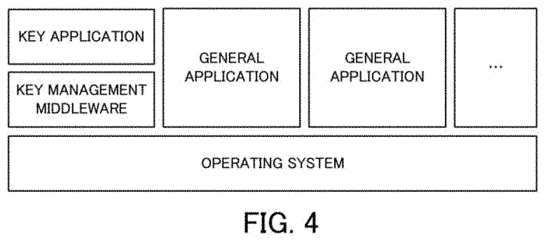

FIG. 4 illustrates a configuration of software operating on the mobile terminal 200. As illustrated, the software operating on the mobile terminal 200 can be broadly divided into an operating system, key management middleware, a key application, and a plurality of general applications.

The key application is an application program that interacts with the user. The user can instruct to acquire or transmit an electronic key through the key application.

The key management middleware manages an electronic key, based on an instruction (for example, API call) from the key application. For example, the key management middleware performs processing of requesting the server apparatus 100 to issue an electronic key, processing of receiving the issued electronic key through a secure communication channel, processing of transmitting an electronic key selected by the user, and the like.

Functions of the authentication request unit 2021 are implemented by the key application and the key management middleware.

The user can run an arbitrary application program (an application program irrelevant to an electronic key) on the mobile terminal 200. For example, the user can run the plurality of general applications installed in the mobile terminal 200. When an electronic key is required, the user can run the key application.

For example, the control unit 202 executes a launcher that is part of the operating system, so that the user can run an arbitrary application program via the launcher.

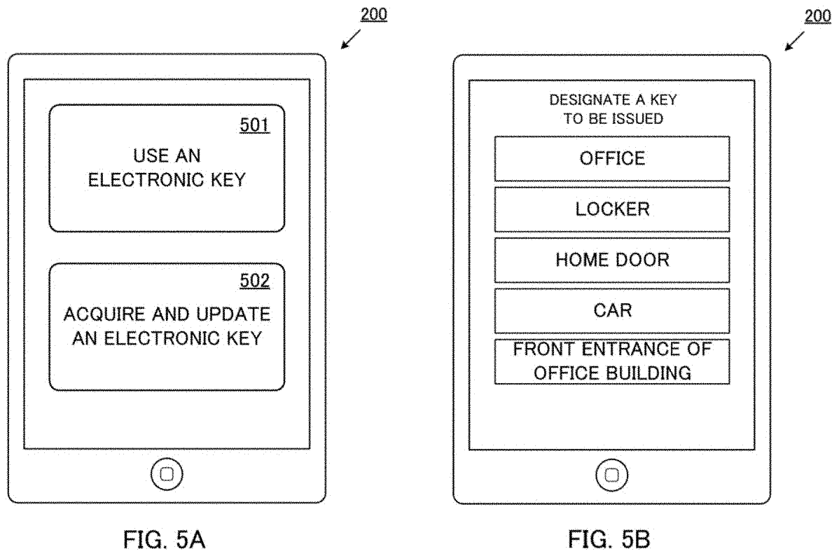

When the user runs the key application, a menu to acquire an electronic key and a menu to use an acquired electronic key are displayed. FIG. 5A is an example of a menu screen. Here, when an area 502 is tapped, transition occurs to a screen to request the server apparatus 100 to issue an electronic key. FIG. 5B is an example of a screen to designate an electronic key that is requested to be issued.

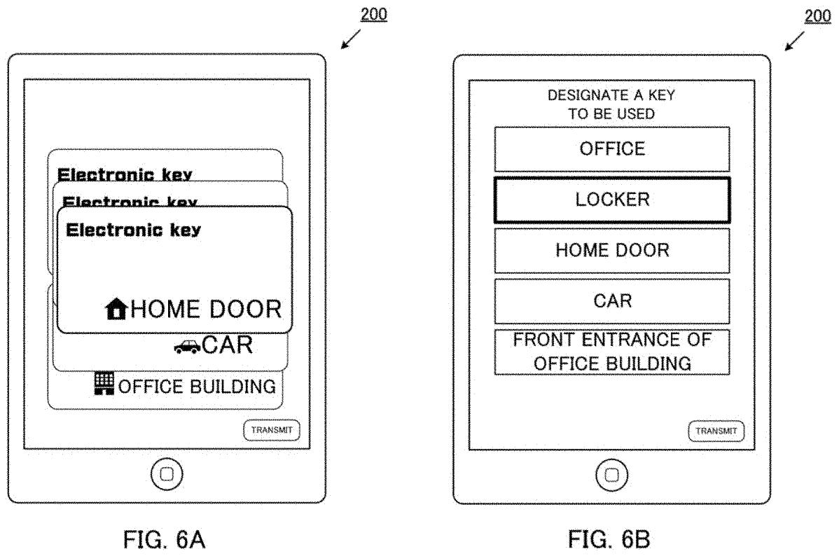

When an area 501 is tapped, transition occurs to a screen to use an electronic key. FIGS. 6A, 6B are examples of a screen to designate an electronic key to be used. In the example in FIG. 6A, a plurality of electronic keys stored in the storage unit 203 are displayed in a scrollable manner, and items can be moved by swiping across the screen. In the present example, by tapping an item (home door) displayed in the middle, “home door” can be brought in a selected state.

In the example in FIG. 6B, the plurality of stored electronic keys are displayed in a list, and an arbitrary item can be brought in a selected state by tapping the item. In the present example, “locker” is in a selected state.

Moreover, when a transmit button is pressed, an electronic key corresponding to the selected item can be transmitted.

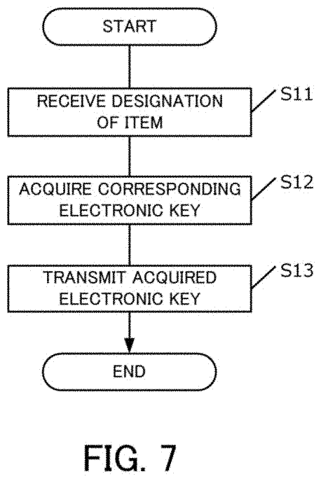

FIG. 7 is a flowchart of processing of allowing the user to select an electronic key. The illustrated processing is started by the authentication request unit 2021 and by activating the key application.

In step S11, a user interface screen as illustrated is generated, to prompt selection of an item.

When the user selects an item, in step S12, an electronic key corresponding to the selected item is acquired from among the plurality of electronic keys stored in the storage unit 203.

In step S13, the acquired electronic key is transmitted to the locking-unlocking apparatus 300 via the short-range communication unit 204.

Note that the authentication request unit 2021 may receive a result of authentication from the locking-unlocking apparatus 300. For example, when authentication succeeds, such a result may be outputted via the input-output unit 205. When authentication fails, such a result and an error code or the like may be outputted via the input-output unit 205.

As described above, in the authentication system according to the first embodiment, a plurality of electronic keys can be stored in the single mobile terminal 200, and an electronic key selected from among the plurality of electronic keys through an operation by the user can be transmitted to the locking-unlocking apparatus 300. Thus, the user can access a plurality of locking-unlocking apparatuses only by carrying a single apparatus.

### Second Embodiment

In the first embodiment, an electronic key to be used is determined based on a selection made by the user. However, a second embodiment is an embodiment in which a history of use of electronic keys is stored, and assistance is provided in an operation of selecting an electronic key (a suggestion is made), based on the history of use.

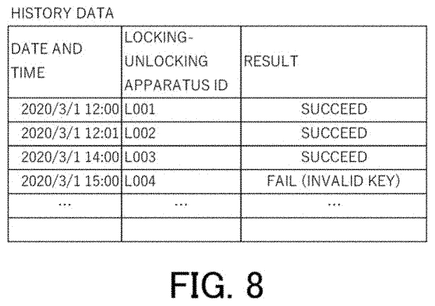

In the second embodiment, when the mobile terminal 200 uses an electronic key, the authentication request unit 2021 generates or updates data indicating a record of use of the electronic key (history data), and has the storage unit 203 store the data. FIG. 8 is an example of the history data. In the history data, a date and time when an electronic key is used, an identifier of a target locking-unlocking apparatus, a result of authentication, and the like are recorded.

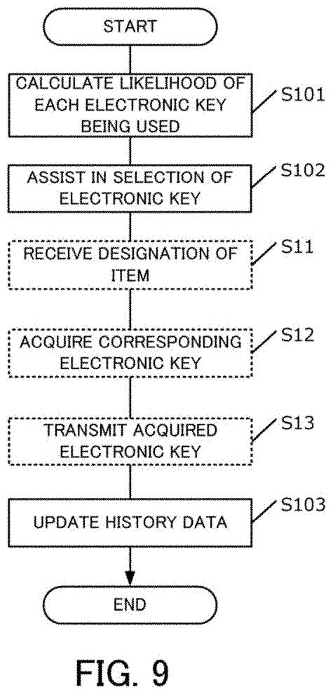

FIG. 9 is a flowchart of electronic key selection processing in the second embodiment.

In the present embodiment, in step S101, the authentication request unit 2021 refers to the history data and, for each of the plurality of stored electronic keys, calculates a likelihood (probability) of the electronic key being used.

The likelihood of an electronic key being used can be calculated, for example, based on date and time information. For example, when many records are left indicating that a home was locked sometime between 08:00 and 09:00 hours and was unlocked sometime between 20:00 and 21:00 hours on weekdays, it can be understood that the likelihood is great that an electronic key corresponding to the home door is used between 08:00 and 09:00 hours and between 20:00 and 21:00 hours on weekdays. When many records are left indicating entry into an office sometime between 09:00 and 10:00 hours and leaving of the office sometime between 19:00 and 20:00 on weekdays, it can be understood that the likelihood is great that an electronic key corresponding to the office is used between 09:00 and 10:00 hours and between 19:00 and 20:00 on weekdays.

The calculation of a likelihood based on the history data can be carried out by using a publicly known technique. For example, a likelihood may be calculated for each of the plurality of electronic keys by using a machine learning model.

In step S102, the authentication request unit 2021 assists in the operation of selecting an electronic key (makes a suggestion), based on the calculated likelihood.

For example, in the examples in FIGS. 6A, 6B, an item with the greatest likelihood may be brought in an already selected state. When the list display is rendered, items may be sorted based on the likelihoods. For example, a plurality of items may be sorted so that an item with a greater likelihood is displayed higher on the list. An item may be highlighted based on the likelihood.

Steps S11 to S13 are similar to the steps in the first embodiment, and therefore a description thereof is omitted. In the second embodiment, after an electronic key is transmitted, the authentication request unit 2021 updates the history data (step S103).

According to the second embodiment, an item can be selected through more simplified operation.

### Third Embodiment

A third embodiment is an embodiment in which a suggestion is made, taking into consideration order in which electronic keys are used.

For example, a case will be considered where both a home door and a vehicle (private car) are electronic key-enabled, and where a user goes out using the vehicle. In such a case, when the home door is locked, it is highly probable that the vehicle is unlocked next. Moreover, when the vehicle is locked, it is highly probable that the home door is unlocked next. In the third embodiment, based on such order in which electronic keys are used, the mobile terminal 200 assists in selection of an electronic key.

In the third embodiment, when an electronic key is used, the authentication request unit 2021 generates or updates data indicating a history of use of the electronic key (history data), and has the storage unit 203 store the data, as in the second embodiment.

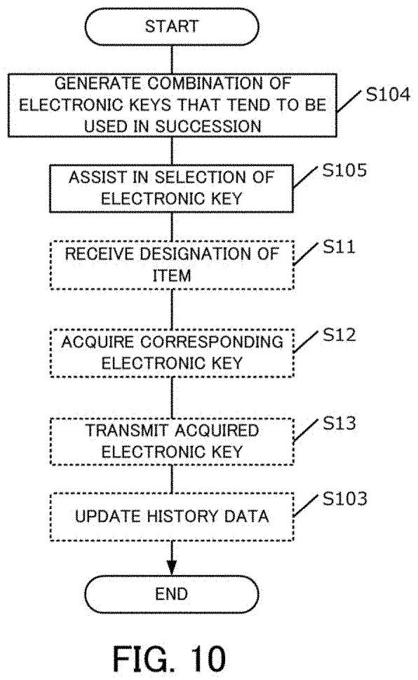

FIG. 10 is a flowchart of electronic key selection processing in the third embodiment.

In the third embodiment, in step S104, the authentication request unit 2021 generates a combination of two or more electronic keys that tend to be used in succession.

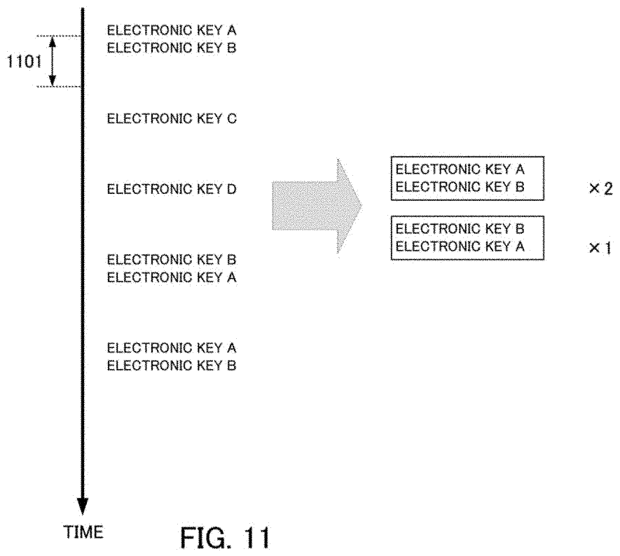

The processing will be described with reference to FIG. 11.

For example, a record indicating that after an electronic key was used, another electronic key was used within a predetermined length of time (reference numeral 1101; for example, one minute, three minutes, or the like) is extracted from history data corresponding to a predetermined period (for example, one month or the like). In the illustrated example, two identical combinations of “electronic key A→electronic key B” and one combination of “electronic key B→electronic key A” are extracted.

Based on the combinations of electronic keys and the numbers of the extracted combinations, a combination of two or more electronic keys that tend to be used in succession is determined. For example, when the number of extracted identical combinations of electronic keys is larger than a threshold value, it is determined that such a combination tends to be used in succession.

In step S105, the combination is used to assist in selection of an electronic key. For example, when the processing illustrated in FIG. 10 is performed within the predetermined length of time after the electronic key A is used, it is determined that a tendency to use the electronic key B next is great, and an item corresponding to the electronic key B is suggested.

As described above, according to the third embodiment, usability can be enhanced in an environment where electronic keys are used in succession.

Note that the processing in step S104 does not necessarily need to be performed every time. For example, the processing in step S104 may be performed independently, in each predetermined period (for example, once a day, or the like). In such a case, the combination generated in step S104 may be temporarily stored in the storage unit 203.

### Fourth Embodiment

Although the user activates the key application in the first to third embodiments, the key application may be automatically activated.

A fourth embodiment is an embodiment in which the mobile terminal 200 detects existence of the locking-unlocking apparatus 300 and automatically executes the key application.

Although the short-range communication unit 204 has a communication range of several centimeters in the above-described embodiments, a communication range of about several meters is secured in the present embodiment.

In the present embodiment, the locking-unlocking apparatus 300 periodically transmits a signal including an own identifier (hereinafter, an advertising signal) in a broadcast manner, and when the short-range communication unit 204 receives the advertising signal, the key application is automatically activated. Based on the identifier included in the advertising signal, assistance is provided in selection of an item in the above-described manner. For example, when an advertising signal is received from the locking-unlocking apparatus 300 corresponding to the electronic key A, an item corresponding to the electronic key A is suggested.

As described above, according to the fourth embodiment, usability can be enhanced because the key application is automatically activated when the mobile terminal 200 comes close to the locking-unlocking apparatus 300, and assistance is provided in selection of an item.

Note that a communication standard for transmitting an electronic key and a communication standard for transmitting an advertising signal may be different. For example, NFC may be used for transmission of an electronic key, and BLE (Bluetooth Low Energy) may be used for transmission of an advertising signal. Note that although the term “advertising signal” is used here, the signal does not necessarily need to be transmitted by using Bluetooth.

### Modification Example of the Fourth Embodiment

Although the user performs operation through the key application in the fourth embodiment, the mobile terminal 200 may automatically select and transmit an electronic key.

For example, when a signal is received from the locking-unlocking apparatus 300 corresponding to the electronic key A, and when the electronic key A is already stored in the mobile terminal 200, a configuration may be made such that the electronic key A is automatically transmitted. According to such a configuration, the user can perform unlocking without touching the mobile terminal 200.

Note that a configuration may be made such that an action of the user is indispensable, not that locking and unlocking are performed fully automatically. For example, confirmation of transmission of an electronic key may be sought on the mobile terminal 200, and the electronic key may be transmitted when an operation of approval is made. Thus, for example, a scenario is possible in which a confirmation message (for example, a push notification) such as “Do you get in this vehicle?” is outputted when the user approaches the vehicle, and unlocking of the vehicle is performed when the user taps on “Yes”.

A locking or unlocking process may be advanced only when any action (for example, pressing of a button, or the like) is taken on the locking-unlocking apparatus 300.

### Fifth Embodiment

A fifth embodiment is an embodiment in which the key application is activated when the user makes a predetermined gesture toward the input-output unit 205 included in the mobile terminal 200.

In the present embodiment, the mobile terminal 200 includes a hardware switch (for example, a sleep button, a home button, a sound volume button, or the like), and the control unit 202 monitors an operation (gesture operation) made on such a switch. When a predetermined gesture is detected, the key application is activated. The predetermined gesture may be, for example, double-clicking or long-pressing. Although the hardware switch is used in the present example, a gesture may be acquired by using other unit. For example, when a predetermined graphic pattern is drawn through a touch screen, the key application may be activated.

According to such a configuration, transmission of an electronic key can be performed through more simplified operation.

### Modification Example

The above-described embodiments are provided only for illustrative purposes, and the present disclosure can be carried out with modifications made as appropriate within a scope that does not depart from a gist of the present disclosure.

For example, the processing and the units described in the present disclosure can be freely combined and implemented, to the extent that there exists no technical conflict.

The processing described as being performed by a single apparatus may be performed by a plurality of apparatuses in a divided manner. Alternatively, the processing described as being performed by different apparatuses may be performed by a single apparatus. It can be flexibly changed what hardware component or components (server component or components) are used to implement each function in a computer system.

The present disclosure can also be implemented in such a manner that a computer program packaging the functions described in the embodiments above is provided to a computer, and that one or more processors included in the computer read and execute the program. Such a computer program may be provided to the computer by using a non-transitory computer-readable storage medium that can connect to a system bus of the computer, or may be provided to the computer via a network. Examples of the non-transitory computer-readable storage medium include any types of disks such as magnetic disks (Floppy® disk, hard disk drive (HDD), and the like) and optical disks (CD-ROM, DVD disk, Blu-ray Disc, and the like), a read only memory (ROM), a random access memory (RAM), an EPROM, an EEPROM, a magnetic card, a flash memory, an optical card, and any types of media suitable to store electronic instructions.

What is claimed is:

1. An information processing apparatus, comprising:
a storage configured to store two or more electronic keys corresponding to two or more locking-unlocking apparatuses, respectively; and
a controller configured to perform
selection of an electronic key to be used, from among the two or more electronic keys, and
transmission of the selected electronic key to a corresponding locking-unlocking apparatus of the two or more locking-unlocking apparatuses.

2. The information processing apparatus according to claim 1, wherein
the controller receives, from any one of the two or more locking-unlocking apparatuses that is in a vicinity of the information processing apparatus, an identifier of the locking-unlocking apparatus, and selects and transmits the electronic key to be used, based on the identifier.

3. The information processing apparatus according to claim 1, further comprising
an input-output unit configured to present information to a user and to acquire an input from the user,
wherein the controller outputs a list of the two or more electronic keys to the input-output unit, and selects the electronic key to be used, based on an operation by the user.

4. The information processing apparatus according to claim 3, wherein
the controller is capable of executing a first program that performs the selection and the transmission of the electronic key, and
activates the first program when a predetermined gesture is detected through the input-output unit.

5. The information processing apparatus according to claim 4, wherein
the controller activates the first program when it is detected that at least any one of the two or more locking-unlocking apparatuses is in a vicinity of the information processing apparatus.

6. The information processing apparatus according to claim 5, wherein
the controller receives, from the locking-unlocking apparatus in the vicinity, an identifier of the locking-unlocking apparatus, and selects the electronic key to be used, based on the identifier.

7. The information processing apparatus according to claim 3, wherein the controller
stores a history of use of each of the two or more electronic keys to the storage, and
performs presentation of an electronic key candidate predicted to be used to the user, based on the history of use.

8. The information processing apparatus according to claim 7, wherein
the controller calculates a likelihood of each of the two or more electronic keys being used, based on the history of use, and performs the presentation, based on the likelihoods.

9. The information processing apparatus according to claim 7, wherein
the controller extracts a combination of two or more electronic keys that tend to be used in succession, based on the history of use, and
when a first electronic key is used, performs presentation to the user of a second electronic key that tends to be used following the first electronic key.

10. The information processing apparatus according to claim 7, wherein
the presentation is performed by highlighting a target electronic key included in the list.

11. An information processing method, comprising:
acquiring two or more electronic keys corresponding to two or more locking-unlocking apparatuses, respectively;
selecting an electronic key to be used, from among the two or more electronic keys; and
transmitting the selected electronic key to a corresponding locking-unlocking apparatus of the two or more locking-unlocking apparatuses.

12. The information processing method according to claim 11, wherein
from any one of the two or more locking-unlocking apparatuses that is in a vicinity, an identifier of the locking-unlocking apparatus is received, and the electronic key to be used is selected and transmitted, based on the identifier.

13. The information processing method according to claim 11, wherein
a list of the two or more electronic keys is presented to a user, and the electronic key to be used is selected, based on an operation by the user.

14. The information processing method according to claim 13, wherein
when a predetermined gesture is detected through an input-output unit, a first program that performs the selecting and the transmitting the electronic key is activated.

15. The information processing method according to claim 14, wherein
when it is detected that at least any one of the two or more locking-unlocking apparatuses is in a vicinity, the first program is activated.

16. The information processing method according to claim 15, wherein
from the locking-unlocking apparatus in the vicinity, an identifier of the locking-unlocking apparatus is received, and the electronic key to be used is selected, based on the identifier.

17. The information processing method according to claim 13, further comprising
acquiring a history of use of each of the two or more electronic keys,
wherein an electronic key candidate predicted to be used is presented to the user, based on the history of use.

18. The information processing method according to claim 17, wherein
a likelihood of each of the two or more electronic keys being used is calculated based on the history of use, and the presentation is performed based on the likelihoods.

19. The information processing method according to claim 17, wherein
a combination of two or more electronic keys that tend to be used in succession is extracted based on the history of use, and
when a first electronic key is used, a second electronic key that tends to be used following the first electronic key is presented to the user.

20. A non-transitory computer readable storing medium recording a computer program for causing a computer to perform the information processing method according to claim 11.
